(19) United States
(12) Patent Application Publication
(10) Pub. No.: US 2023/0009773 A1
(43) Pub. Date: Jan. 12, 2023

(54) PET WASTE LINER WITH ABSORBABLE PAD

(71) Applicant: Alana Nicole Lambert, Conway, AR (US)

(72) Inventor: Alana Nicole Lambert, Conway, AR (US)

(21) Appl. No.: 17/372,910

(22) Filed: Jul. 12, 2021

(51) Int. Cl. A01K 1/01

(52) U.S. Cl. CPC A01K 1/0107

(57) ABSTRACT

A pet waste liner equipped with an absorbable pad is disclosed. The invention is designed to be used with a pet litter box to collect pet waste. The invention comprises a liquid-proof plastic bag which is made of High-Density Polyethylene (HDPE) or any other suitable material, an elastic band around the opening and an absorbable pad which is attached to the base of the liner to capture all liquids that may be deposited by the pet.

### FIELD OF THE INVENTION

The disclosed invention relates to pet waste disposal equipment, and more particularly a pet waste liner with an absorbable pad.

### BACKGROUND OF THE INVENTION

The present invention is designed to be used with a pet litter box for a safe and proper disposal of pet waste. A litter box, sometimes referred to as a sandbox, cat box, litter tray, cat pan, or litter pan, is a device used for the indoor collection of pet feces and urine. The litter box is usually suitable for cats, rabbits, ferrets, miniature pigs, small dogs, and other pets that impulsively or by training make use of such a depository. As such, they are suitable for pets that are allowed to freely roam a home but cannot go outside the home to excrete their metabolic waste.

The problem with using litter boxes is that they get messy with each use and the owner or care giver of the pet will have to clean the litter box as often as necessary which can be quite tedious. The present invention, is provided to be used in lining the inside of a pet litter box in order to keep it sanitary and clean even after use by the pet.

There are various types of pet waste liner solutions available in the market. However, the problem with them is that they fail to absorb liquids that may have been deposited into them. This can potentially lead to an unsanitary environment if the waste liner is not disposed as soon as the pet excretes their waste.

The present invention, therefore, provides a pet waste liner equipped with an absorbable pad to overcome the aforementioned shortcomings of regular pet waste liners.

### SUMMARY OF THE INVENTION

The proposed solution is a pet waste liner equipped with an absorbable pad at the bottom and designed to be used with a pet litter box to collect pet waste in a safe, effective and sanitary manner. The invention consists of liquid-proof plastic bag which is made of High-Density Polyethylene (HDPE) or any other suitable material, an elastic band around the opening to allow the easy putting on and taking off a pet litter box/tray. The invention further comprises an absorbable pad which is attached to the base of the liner to capture all liquids that may be deposited by the pet.

The type of material used in producing the absorbable pad may vary and this list may include a leak proof paper base comprising hot rolled non-woven fabric, wrapping paper, wood pulp absorbent paper, wrapping paper, leakproof PE lamination and cast film all pressed into one to form the absorbable pad. It is also worthy of note that the present invention may come in multiple sizes, and the plastic bag material may be subject to change to accommodate the use of more eco-friendly materials. The invention allows pet owners to easily pick up pet waste in one pickup.

### BRIEF DESCRIPTION OF FIGURES

FIG. 1 is a top view of the present invention;

FIG. 2 is a perspective view of the present invention;

FIG. 3 is a top view showing the present invention attached to a pet litter box.

### DETAILED DESCRIPTION

The invention will now be described in detail with references made to the accompanying drawings.

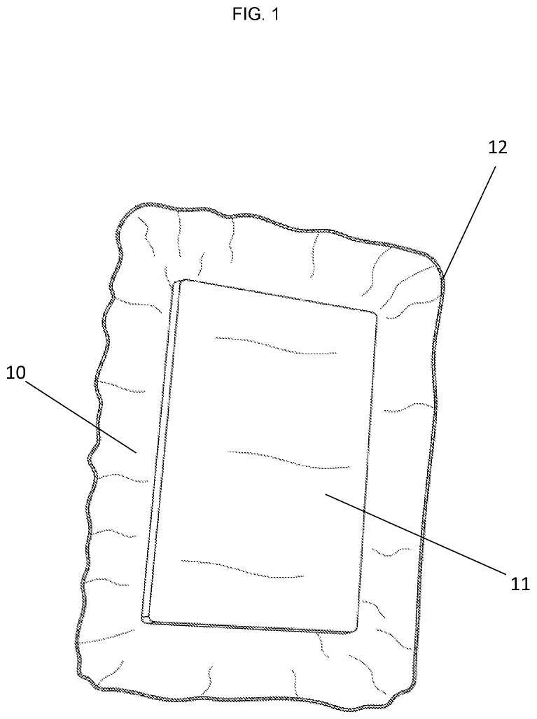

FIG. 1 discloses a top view of the present invention comprising a liquid-proof plastic bag 10, an elastic band 12 around the opening, and an absorbable pad 11 attached to the base of the plastic bag 10.

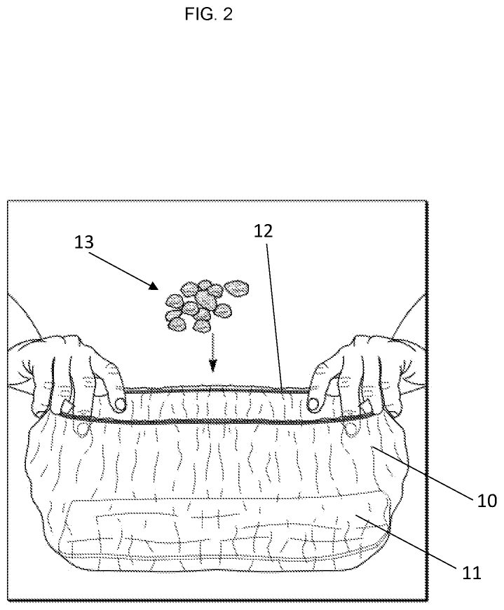

FIG. 2 discloses a perspective view of how the present invention works. This view comprises the liquid-proof plastic bag 10, an elastic band 12 around the opening, and an absorbable pad 11 attached to the base of the plastic bag 10 and 13 is pet waste.

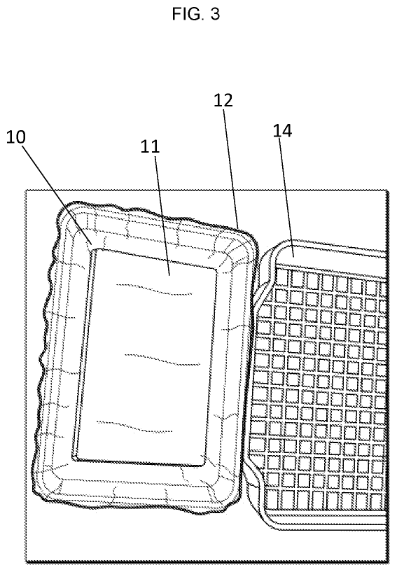

FIG. 3 discloses a full illustration of the use of the present invention attached to a pet litter box/tray 14. This view comprises the liquid-proof plastic bag 10, an elastic band 12 around the opening, and an absorbable pad 11 attached to the base of the plastic bag 10 and the litter box/tray 14.

### HOW THE INVENTION IS USED

The present invention (pet waste liner) is fixed into the inside of a pet waste litter box or tray, thereby, allowing the pet to pass urine and feces into the lined litter box. The absorbable padding soaks up any liquids that may have been deposited into the litter box, and once the pet is done, its owner can easily carry and dispose the pet waste in one pickup without messing up the litter box itself.

What is claimed:

1. A pet waste liner comprising a liquid-proof bag, an elastic band and an absorbable pad;

2. A pet waste liner according to claim 1 whereby the said liquid-proof bag is made of High-density polyethylene (HDPE) or any suitable liquid-proof material;

3. A pet waste liner according to claim 1 whereby the said elastic band goes around the opening of the liquid-proof bag;

4. A pet waste liner according to claim 1 whereby the said absorbable pad soaks up any liquid waste that may be deposited into a pet litter box/tray by the pet.
